(19) United States
(12) Patent Application Publication
(10) Pub. No.: US 2025/0360642 A1
(43) Pub. Date: Nov. 27, 2025

(54) ADJUSTABLE STRUCTURE OF FOOD SLICER

(71) Applicant: Congqiang LU, Taizhou (CN)

(72) Inventor: Congqiang LU, Taizhou (CN)

(21) Appl. No.: 18/921,970

(22) Filed: Oct. 21, 2024

(30) Foreign Application Priority Data
May 25, 2024 (CN) 202421162479.4

(51) Int. Cl. B26D 7/26; B26D 1/02

(52) U.S. Cl. CPC B26D 7/2628; B26D 1/02; B26D 2210/02

(57) ABSTRACT

Disclosed is an adjustable structure of a food slicer. A planer body includes an upper cutting plate and a back plate, a lower cutting plate is movably disposed on the planer body and at a front side of the back plate, the lower cutting plate is driven by the adjustable structure to move on the planer body to adjust a height difference between an upper plane of the upper cutting plate and an upper plane of the lower cutting plate. According to the present application, with the adoption of the meshing transmission of the sliding teeth and the gear, a linear motion in the up-down direction is converted into a lifting motion of the lower cutting plate in cooperation with the chutes, the transmission is stable and the adjustment is fast and convenient.

### CROSS-REFERENCE TO RELATED APPLICATIONS

This application claims priority to Chinese Patent Application No. 202421162479.4, filed on May 25, 2024, the content of which is incorporated herein by reference in its entirety.

### TECHNICAL FIELD

The present application belongs to the technical field of food slicers, and in particular to an adjustable structure of a food slicer.

### BACKGROUND

A food slicer is a widely used kitchen product at present, which can be used for shredding or slicing. The existing food slicer includes a planer body, where an upper cutting plate is disposed on the planer body, a stationary knife is disposed at a lower end of an upper cutting plate, and a lower cutting plate is movably disposed on the planer body and at a front side of a back plate, and a first cutter and a second cutter can extend out of the lower cutting plate and shredding can be implemented at this time, or the first cutter and the second cutter can be retracted below the lower cutting plate and slicing can be implemented at this time. Due to the variety of ingredients, according to the needs of cooking, the requirements for thicknesses of slicing and shredding will be different. Therefore, it is necessary to provide an adjustable structure to adjust a height difference between an upper plane of the upper cutting plate and an upper plane of the lower cutting plate, and finally to adjust the thickness of slicing and shredding.

### SUMMARY

The present application aims to provide an adjustable structure of a food slicer with stable transmission and convenient adjustment.

The adjustable structure is implemented as follows: an adjustable structure of a food slicer, the food slicer including a planer body, where the planer body includes an upper cutting plate and a back plate, a lower cutting plate is movably disposed on the planer body and at a front side of the back plate, the lower cutting plate is driven by the adjustable structure to move on the planer body to adjust a height difference between an upper plane of the upper cutting plate and an upper plane of the lower cutting plate, the adjustable structure includes chutes formed in a left side wall and a right side wall of the planer body, and a sliding plate connected to a back surface of the lower cutting plate, inclined ribs slidably disposed in the chutes are disposed at two ends of the sliding plate, sliding teeth are formed on a rear side surface of the sliding plate, a knob is disposed at the back plate, the knob is connected with a gear and drives the gear to rotate, and the gear is in meshing transmission with the sliding teeth to drive the inclined ribs of the sliding plate to move along the chutes, so as to drive the lower cutting plate to move.

In the adjustable structure of the food slicer, the gear includes a knob connecting part and a gear part, a knob fixing plate is disposed on the back plate, a first knob mounting hole is formed in the back plate, a second knob mounting hole is formed in the knob fixing plate, a diameter of the first knob mounting hole is greater than that of the second knob mounting hole, the knob connecting part comprises a first outer ring and a second outer ring, the first outer ring is adapted to the first knob mounting hole, the second outer ring is adapted to the second knob mounting hole, the knob fixing plate is pressed on a step surface formed by the first outer ring and the second outer ring, the gear part passes through the first knob mounting hole and is meshed with the sliding teeth, and the knob connecting part is rotatably disposed in the first knob mounting hole and the second knob mounting hole.

In the adjustable structure of the food slicer, the knob fixing plate is provided with an open-loop or closed-loop concave gear ring, the concave gear ring is coaxially disposed with the second knob mounting hole, the knob covers the concave gear ring, a limiting column mounting hole is formed in the knob, a limiting column is disposed in the limiting column mounting hole through a first elastic piece, and a lower end of the limiting column abuts against a groove of the concave gear ring for positioning.

In the adjustable structure of the food slicer, a guide ring is disposed at an outer side of the concave gear ring, a guide block is disposed at a bottom surface of the knob, and the guide block is capable of moving in the guide ring.

In the adjustable structure of the food slicer, the knob fixing plate is provided with a plurality of elastic buckles along an outer contour of the knob fixing plate, clamping holes with the number and positions corresponding to those of the elastic buckles one by one are formed in the back plate in corresponding positions, and the knob fixing plate is clamped in the clamping holes through the elastic buckles and thus connected with the back plate.

In the adjustable structure of the food slicer, more than two clamping holes are distributed in the connecting part of the knob circumferentially, chucks are disposed in the clamping holes, elastic clamping strips with the number and positions corresponding to those of the clamping holes one by one are disposed in the bottom surface of the knob, limiting holes are formed in the elastic clamping strips, the elastic clamping strips are inserted into the clamping holes, the chucks are positioned in the limiting holes to connect the knob and the knob connecting part.

In the adjustable structure of the food slicer, the back plate is provided with a first guide groove and a second guide groove in a left-right direction, a first through hole and a second through hole are formed in the left side wall and the right side wall of the planer body respectively, the first through hole is communicated with the first guide groove and the second through hole is communicated with the second guide groove, a first movable hole and a second movable hole are formed in the knob fixing plate, a first sliding button and a second sliding button are respectively elastically disposed in the first guide groove and the second guide groove through second elastic pieces, outer ends of the first sliding button and the second sliding button extend out of the left side wall and the right side wall of the planer body through the first through hole and the second through hole, and sliding driving parts of the first sliding button and the second sliding button are capable of moving in the first movable hole and the second movable hole.

In the adjustable structure of the food slicer, a strip-shaped mounting hole is formed in a middle part of the back plate in an up-down direction, positioning columns are disposed in portions, located in the strip-shaped mounting hole, of the sliding plate at an interval from left to right, cylindrical chutes are formed in the positioning columns, the sliding teeth are provided with a waist part, positioning pins are disposed at the waist part, the sliding teeth are disposed between the two positioning columns and clamped in the strip-shaped mounting hole, the positioning columns are located at the waist part of the sliding teeth, and the positioning pins of the sliding teeth are disposed in the cylindrical chutes.

In the adjustable structure of the food slicer, two strip-shaped holes are formed in the sliding plate in an interval from left to right, fifth elastic buckles corresponding to positions of the strip-shaped holes one by one are disposed at the back surface of the lower cutting plate, and the fifth elastic buckles pass through the strip-shaped holes and are clamped with the sliding plate.

In the adjustable structure of the food slicer, an insertion hole is formed in a lower end of the back plate, an insertion column is disposed at a corresponding position of the lower cutting plate, and the insertion column is inserted into the insertion hole.

Compared with the prior art, the present application has the following outstanding advantages.

Firstly, according to the present application, with the adoption of the meshing transmission of the sliding teeth and the gear, a linear motion in the up-down direction is converted into a lifting motion of the lower cutting plate in cooperation with the chutes, the transmission is stable and the adjustment is fast and convenient simply by turning the knob.

Lastly, according to the present application, the lower cutting plate and the sliding plate, and the knob fixing plate and the back plate are connected by buckles, so that the connection is reliable, and the assembly and disassembly are convenient, without tools.

### BRIEF DESCRIPTION OF THE DRAWINGS

FIG. 1 is an exploded schematic diagram of the present application.

FIG. 2 is a perspective view of the present application.

FIG. 3 is a front view of the present application.

FIG. 4 is a sectional view taken along A-A of FIG. 3.

FIG. 5 is a schematic view showing that a stationary knife is mounted on an upper cutting plate and a first cutter and a second cutter extend out of a lower cutting plate.

FIG. 6 is a schematic view of the rear side of the lower cutting plate of the present application.

FIG. 7 is a schematic view of the front side of a sliding plate of the present application.

FIG. 8 is a schematic view of the rear side of the sliding plate of the present application.

FIG. 9 is a schematic view of sliding teeth of the present application.

FIG. 10 is a schematic view of the front side of a knob fixing plate of the present application.

FIG. 11 is a schematic view of the rear side of the knob fixing plate of the present application.

FIG. 12 is a schematic view of the knob of the present application.

FIG. 13 is a schematic view of a gear of the present application.

FIG. 14 is a schematic view of the front side of a planer body of the present application.

FIG. 15 is a schematic view of the rear side of the planer body of the present application.

### DETAILED DESCRIPTION OF THE EMBODIMENTS

In the following, the present application will be further described with specific examples.

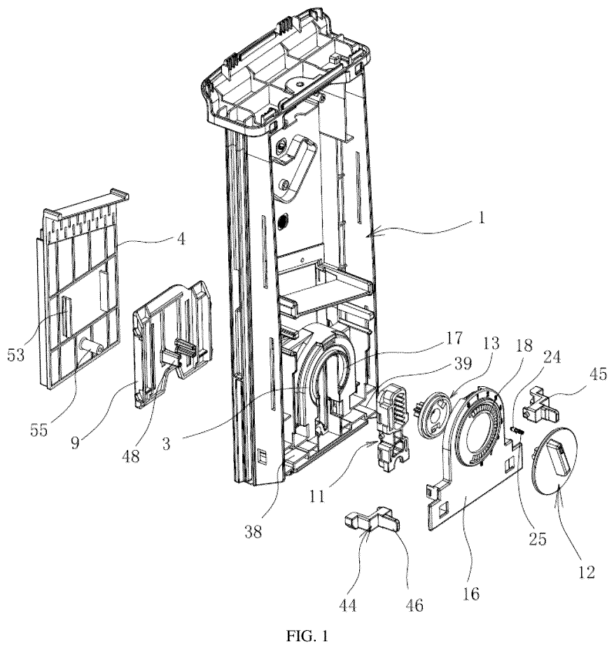

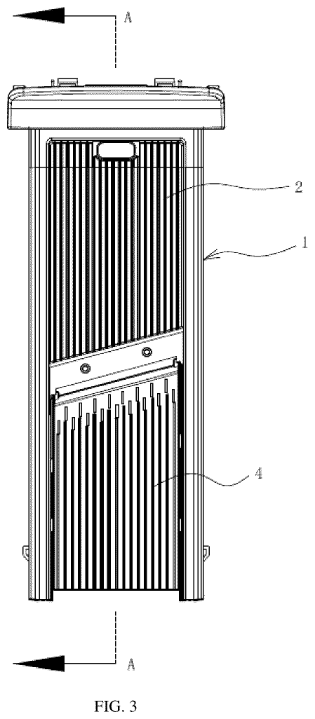

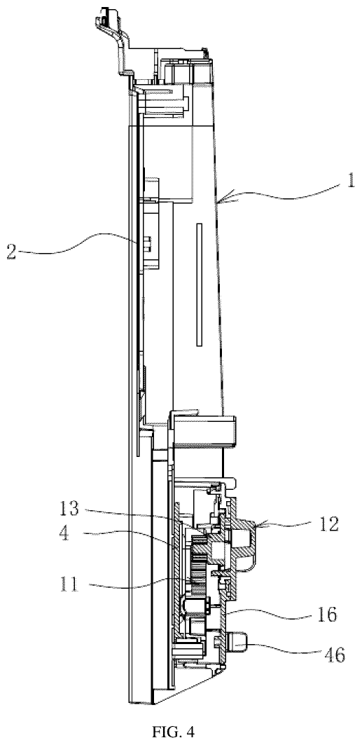

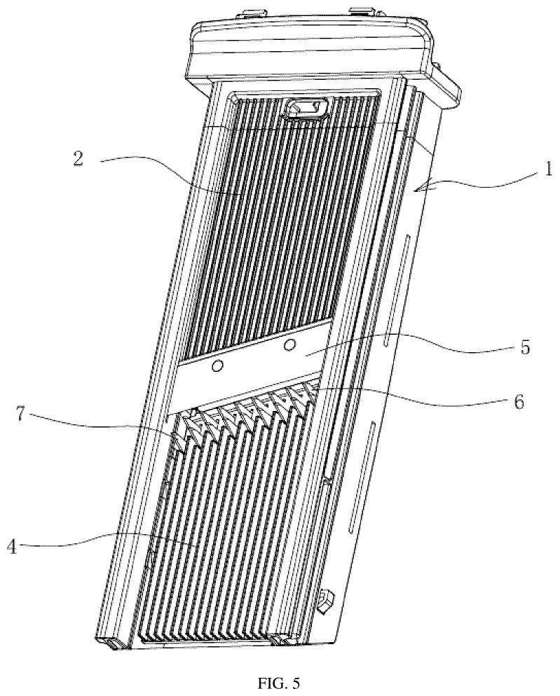

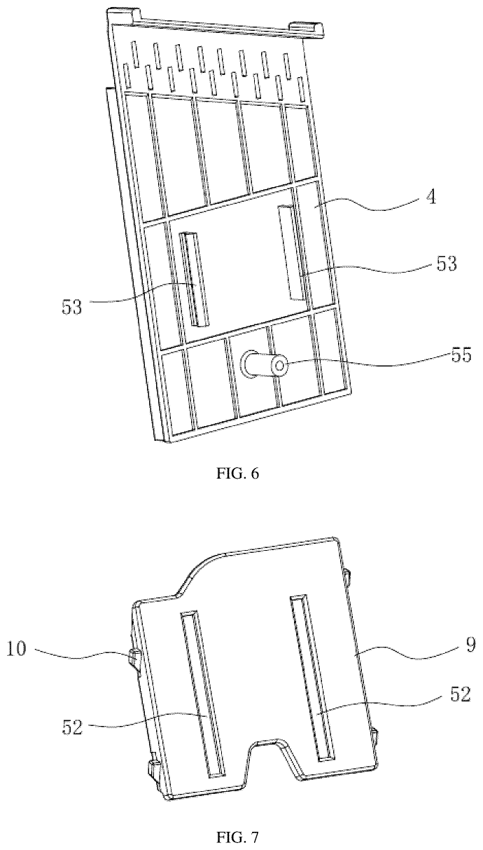

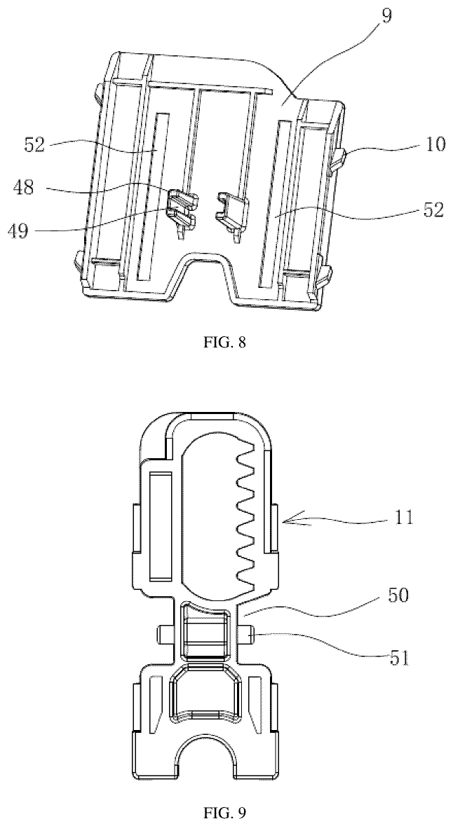

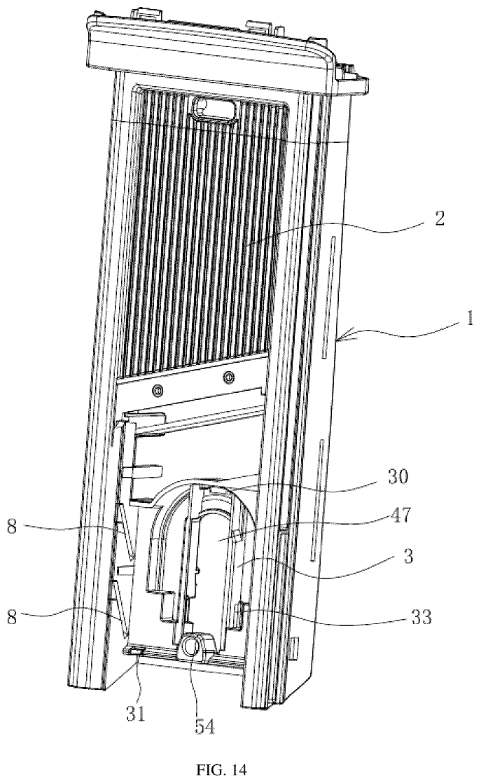

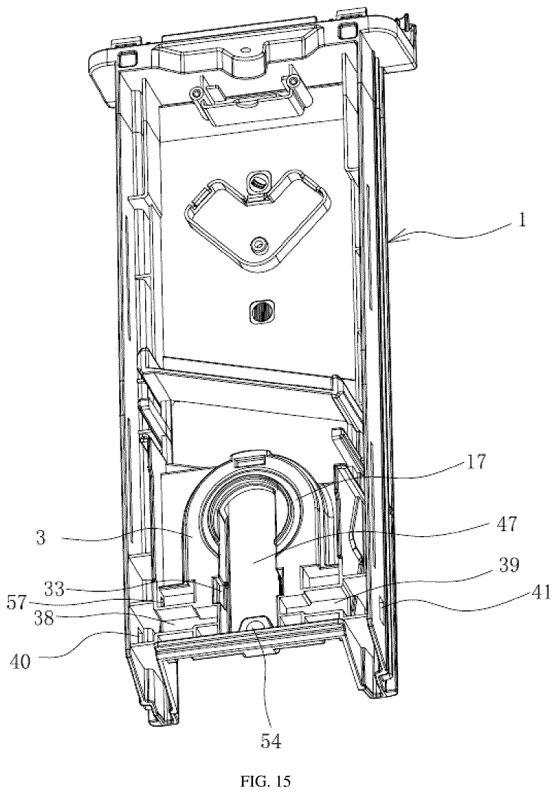

Referring to FIGS. 1-15, the present application provides an adjustable structure of a food slicer. The food slicer includes a planer body 1, the planer body 1 includes an upper cutting plate 2 and a back plate 3, a lower cutting plate 4 is movably disposed on the planer body 1 and at a front side of the back plate 3, and the lower cutting plate 4 is driven by the adjustable structure to move on the planer body 1 to adjust a height difference between an upper plane of the upper cutting plate 2 and an upper plane of the lower cutting plate 4. As shown in FIG. 5, a stationary knife 5 is disposed at a lower end of the upper cutting plate 2, the first cutter 6 and the second cutter 7 extend out of the lower cutting plate 4, and the first cutter 6 and the second cutter 7 can also be retracted below the lower cutting plate 4. Therefore, a purpose of adjusting a position of the lower cutting plate 4 in the present application is to adjust a thickness of food to be cut. The adjustable structure includes chutes 8 formed in a left side wall and a right side wall of the planer body 1, and a sliding plate 9 connected to a back surface of the lower cutting plate 4, inclined ribs 10 slidably disposed in the chutes 8 are disposed at two ends of the sliding plate 9, sliding teeth 11 are formed on a rear side surface of the sliding plate 9, a knob 12 is disposed at the back plate 3, the knob 12 is connected with a gear 13 and drives the gear to rotate, and the gear 13 is in meshing transmission with the sliding teeth 11 to drive the inclined ribs 10 of the sliding plate 9 to move along the chutes 8, so as to drive the lower cutting plate 4 to move.

According to the present application, with the adoption of the meshing transmission of the sliding teeth 11 and the gear 13, a linear motion in the up-down direction is converted into a lifting motion of the lower cutting plate 4 in cooperation with the chutes 8, the transmission is stable and the adjustment is fast and convenient simply by turning the knob 12.

Further, as shown in FIGS. 1-4 and FIGS. 10-13, the gear 13 includes a knob connecting part 14 and a gear part 15, a knob fixing plate 16 is disposed on the back plate 3, a first knob mounting hole 17 is formed in the back plate 3, a second knob mounting hole 18 is formed in the knob fixing plate 16, a diameter of the first knob mounting hole 17 is greater than that of the second knob mounting hole 18, the knob connecting part 14 includes a first outer ring 19 and a second outer ring 20, the first outer ring 19 is adapted to the first knob mounting hole 17, the second outer ring 20 is adapted to the second knob mounting hole 18, and the knob fixing plate 16 is pressed on a step surface 21 formed by the first outer ring 19 and the second outer ring 20, so that the gear 13 can be axially limited. The gear part 15 passes through the first knob mounting hole 17 and is meshed with the sliding teeth 11, and the knob connecting part 14 is rotatably disposed in the first knob mounting hole 17 and the second knob mounting hole 18.

In order to achieve the positioning of the knob 12 after rotation, that is, to achieve a gear shifting effect, the knob fixing plate 16 is provided with an open-loop or closed-loop concave gear ring 22, the concave gear ring 22 is coaxially disposed with the second knob mounting hole 18, the knob 12 covers the concave gear ring 22, a limiting column mounting hole 23 is formed in the knob 12, a limiting column 24 is disposed in the limiting column mounting hole 23 through a first elastic piece 25, and a lower end of the limiting column 24 abuts against a groove of the concave gear ring 22 for positioning. Generally, the first elastic piece 25 is a spring. The first elastic piece 25 exerts a function of setting a gear position. In the present application, 0-8 gear positions are set on the knob fixing plate 16, and corresponding gear position numbers are marked. When a linear rib on the knob 12 is rotated and faces a gear position number, the gear position number can be used to determine a current gear position, which is simple and clear. The different height difference between the upper plane of the upper cutting plate 2 and the upper plane of the lower cutting plate 4 is adjusted with respect to different gear positions.

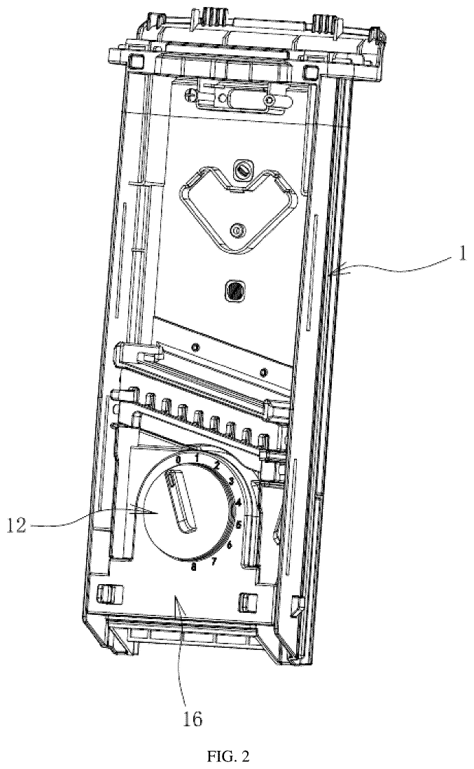

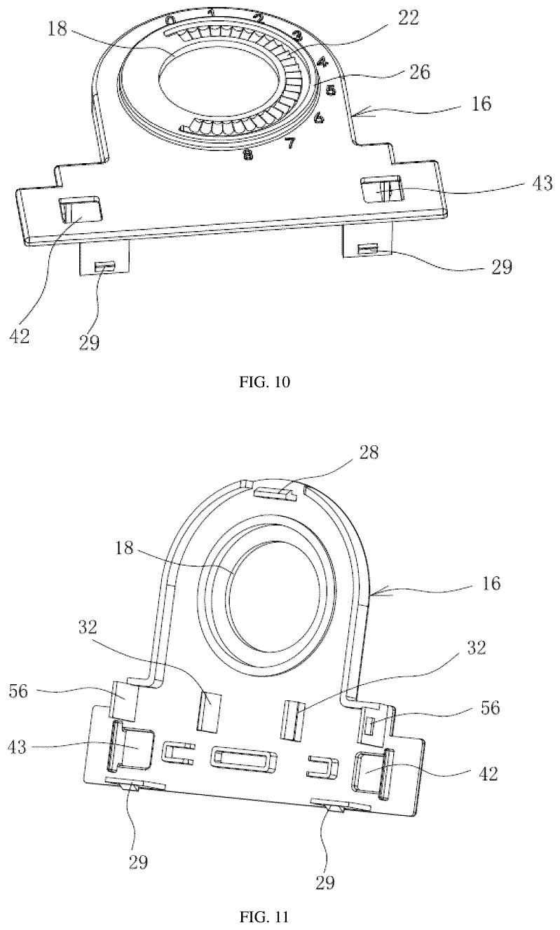

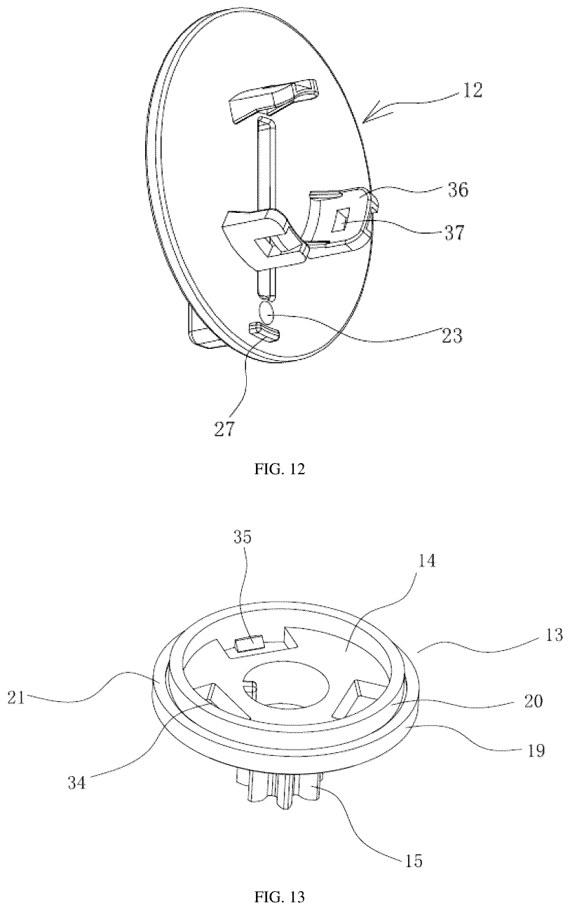

As shown in FIG. 1, FIG. 2, FIG. 10 and FIG. 12, in order to make the knob 12 rotate steadily and smoothly, a guide ring 26 is disposed at an outer side of the concave gear ring 22, a guide block 27 is disposed at a bottom surface of the knob 12, and the guide block 27 is capable of moving in the guide ring 26.

The knob fixing plate 16 of the present application is detachably connected with the back plate 3, and in this embodiment, a clamping connection mode is adopted as follows.

A first elastic buckle 28 is disposed at an upper end of the knob fixing plate 16, and second elastic buckles 29 are disposed at a lower end of the knob fixing plate, and a specific number of the second elastic buckles is two. A third elastic buckle 32 and a fourth elastic buckle 56 are disposed between the first elastic buckle 28 and each of the second elastic buckles 29 on the knob fixing plate 16, a first clamping hole 30, second clamping holes 31, third clamping holes 33 and fourth clamping holes 57 are formed in corresponding positions on the back plate 3, the knob fixing plate 16 is clamped in the first clamping hole 30 through the first elastic buckle 28, the second elastic buckles 29 are clamped in the second clamping holes 31, the third elastic buckles 32 are clamped in the third clamping holes 33, and the fourth elastic buckles 56 are clamped in the fourth clamping holes 57 to connect with the back plate 3.

The above-described connection mode makes the connection between the knob fixing plate 16 and the back plate 3 firm and reliable. With the adoption of the clamping connection mode, disassembly can be realized without tools, which is convenient.

In addition, in the present application, a connecting structure of the knob 12 and the knob connecting part 14 also adopts the clamping connection mode which is specifically as follows: more than two clamping holes 34 are distributed in the connecting part of the knob 14 circumferentially, chucks 35 are disposed in the clamping holes 34, elastic clamping strips 36 with the number and positions corresponding to those of the clamping holes 34 one by one are disposed in the bottom surface of the knob 12, limiting holes 37 are formed in the elastic clamping strips 36, the elastic clamping strips 36 are inserted into the clamping holes 34, the chucks 35 are positioned in the limiting holes 37 to connect the knob 12 and the knob connecting part 14.

In order to connect the present application to a housing of the food slicer, the back plate 3 is provided with a first guide groove 38 and a second guide groove 39 in a left-right direction, a first through hole 40 and a second through hole 41 are formed in the left side wall and the right side wall of the planer body 1 respectively, the first through hole 40 is communicated with the first guide groove 38 and the second through hole 41 is communicated with the second guide groove 39, a first movable hole 42 and a second movable hole 43 are formed in the knob fixing plate 16, a first sliding button 44 and a second sliding button 45 are respectively elastically disposed in the first guide groove 38 and the second guide groove 39 through second elastic pieces, outer ends of the first sliding button 44 and the second sliding button 45 extend out of the left side wall and the right side wall of the planer body 1 through the first through hole 40 and the second through hole 41, and sliding driving parts 46 of the first sliding button 44 and the second sliding button 45 are capable of moving in the first movable hole 42 and the second movable hole 43. Generally, the second elastic piece adopts a spring.

During mounting, a thumb and a forefinger move the driving parts 46 of the first sliding button 44 and the second sliding button 45 towards the center, the second elastic piece is compressed, the outer ends of the first sliding button 44 and the second sliding button 45 are retracted, and after the food slicer is connected with the housing, the first sliding button 44 and the second sliding button 45 are released, the second elastic piece is reset and drives the outer ends of the first sliding button 44 and the second sliding button 45 to extend out of the left side wall and the right side wall of the planer body 1 through the first through hole 40 and the second through hole 41 and be connected in the corresponding holes in the housing.

During dismounting, the driving parts 46 of the first sliding button 44 and the second sliding button 45 are moved towards the center, and the outer ends of the first sliding button 44 and the second sliding button 45 leave the corresponding holes in the housing, so that the food slicer can be dismounted.

It should be noted that a connecting structure of the sliding teeth 11 and the back plate 3 of the present application is as follows: a strip-shaped mounting hole 47 is formed in a middle part of the back plate 3 in an up-down direction, positioning columns 48 are disposed in portions, located in the strip-shaped mounting hole 47, of the sliding plate 9 at an interval from left to right, cylindrical chutes 49 are formed in the positioning columns 48, the sliding teeth 11 are provided with a waist part 50, positioning pins 51 are disposed at the waist part 50, the sliding teeth 11 are disposed between the two positioning columns 48 and clamped in the strip-shaped mounting hole 47, the positioning columns 48 are located at the waist part 48 of the sliding teeth 11, and the positioning pins 51 of the sliding teeth 11 are disposed in the cylindrical chutes 49.

A connecting structure between the sliding plate 9 and the back plate 3 of the present application is as follows: two strip-shaped holes 52 are formed in the sliding plate 9 at an interval from left to right, fifth elastic buckles 53 corresponding to positions of the strip-shaped holes 52 one by one are disposed at the back surface of the lower cutting plate 4, and the fifth elastic buckles 53 pass through the strip-shaped holes 52 and are clamped with the sliding plate 9.

Further, an insertion hole 54 is formed in a lower end of the back plate 3 of the present application, an insertion column 55 is disposed at a corresponding position of the lower cutting plate 4, and the insertion column 55 is inserted into the insertion hole 54. In this way, the lower cutting plate 4 can only move up and down.

The above-mentioned embodiment is only one of the preferred embodiments of the present application, and it is not intended to limit the scope of implementation of the present application. Therefore, all equivalent changes made according to the shape, structure and principle of the present application should be included in the scope of protection of the present application.

What is claimed is:

1. An adjustable structure of a food slicer, wherein
the food slicer comprises a planer body, the planer body comprises an upper cutting plate and a back plate, a lower cutting plate is movably disposed on the planer body and at a front side of the back plate, and the lower cutting plate is driven by the adjustable structure to move on the planer body to adjust a height difference between an upper plane of the upper cutting plate and an upper plane of the lower cutting plate; and
the adjustable structure comprises chutes formed in a left side wall and a right side wall of the planer body, and a sliding plate connected to a back surface of the lower cutting plate, inclined ribs slidably disposed in the chutes are disposed at two ends of the sliding plate, sliding teeth are formed on a rear side surface of the sliding plate, a knob is disposed at the back plate, the knob is connected with a gear and drives the gear to rotate, and the gear is in meshing transmission with the sliding teeth to drive the inclined ribs of the sliding plate to move along the chutes, so as to drive the lower cutting plate to move.

2. The adjustable structure of the food slicer according to claim 1, wherein
the gear comprises a knob connecting part and a gear part, a knob fixing plate is disposed on the back plate, a first knob mounting hole is formed in the back plate, a second knob mounting hole is formed in the knob fixing plate, a diameter of the first knob mounting hole is greater than that of the second knob mounting hole;
the knob connecting part comprises a first outer ring and a second outer ring, the first outer ring is adapted to the first knob mounting hole, the second outer ring is adapted to the second knob mounting hole, the knob fixing plate is pressed on a step surface formed by the first outer ring and the second outer ring; and
the gear part passes through the first knob mounting hole and is meshed with the sliding teeth, and the knob connecting part is rotatably disposed in the first knob mounting hole and the second knob mounting hole.

3. The adjustable structure of the food slicer according to claim 2, wherein the knob fixing plate is provided with an open-loop or closed-loop concave gear ring, the concave gear ring is coaxially disposed with the second knob mounting hole, the knob covers the concave gear ring, a limiting column mounting hole is formed in the knob, a limiting column is disposed in the limiting column mounting hole through a first elastic piece, and a lower end of the limiting column abuts against a groove of the concave gear ring for positioning.

4. The adjustable structure of the food slicer according to claim 3, wherein a guide ring is disposed at an outer side of the concave gear ring, a guide block is disposed at a bottom surface of the knob, and the guide block is capable of moving in the guide ring.

5. The adjustable structure of the food slicer according to claim 2, wherein the knob fixing plate is provided with a plurality of elastic buckles along an outer contour of the knob fixing plate, clamping holes with the number and positions corresponding to those of the elastic buckles one by one are formed in the back plate in corresponding positions, and the knob fixing plate is clamped in the clamping holes through the elastic buckles and thus connected with the back plate.

6. The adjustable structure of the food slicer according to claim 2, wherein more than two clamping holes are distributed in the connecting part of the knob circumferentially, chucks are disposed in the clamping holes, elastic clamping strips with the number and positions corresponding to those of the clamping holes one by one are disposed in the bottom surface of the knob, limiting holes are formed in the elastic clamping strips, the elastic clamping strips are inserted into the clamping holes, and the chucks are positioned in the limiting holes to connect the knob and the knob connecting part.

7. The adjustable structure of the food slicer according to claim 2, wherein the back plate is provided with a first guide groove and a second guide groove in a left-right direction, a first through hole and a second through hole are formed in the left side wall and the right side wall of the planer body respectively, the first through hole is communicated with the first guide groove and the second through hole is communicated with the second guide groove, a first movable hole and a second movable hole are formed in the knob fixing plate, a first sliding button and a second sliding button are respectively elastically disposed in the first guide groove and the second guide groove through second elastic pieces, outer ends of the first sliding button and the second sliding button extend out of the left side wall and the right side wall of the planer body through the first through hole and the second through hole, and sliding driving parts of the first sliding button and the second sliding button are capable of moving in the first movable hole and the second movable hole.

8. The adjustable structure of the food slicer according to claim 1, wherein a strip-shaped mounting hole is formed in a middle part of the back plate in an up-down direction, positioning columns are disposed in portions, located in the strip-shaped mounting hole, of the sliding plate at an interval from left to right, cylindrical chutes are formed in the positioning columns, the sliding teeth are provided with a waist part, positioning pins are disposed at the waist part, the sliding teeth are disposed between the two positioning columns and clamped in the strip-shaped mounting hole, the positioning columns are located at the waist part of the sliding teeth, and the positioning pins of the sliding teeth are disposed in the cylindrical chutes.

9. The adjustable structure of the food slicer according to claim 1, wherein two strip-shaped holes are formed in the sliding plate in an interval from left to right, fifth elastic buckles corresponding to positions of the strip-shaped holes one by one are disposed at the back surface of the lower cutting plate, and the fifth elastic buckles pass through the strip-shaped holes and are clamped with the sliding plate.

10. The adjustable structure of the food slicer according to claim 9, wherein an insertion hole is formed in a lower end of the back plate, an insertion column is disposed at a corresponding position of the lower cutting plate, and the insertion column is inserted into the insertion hole.
